(19) United States
(12) Patent Application Publication
(10) Pub. No.: US 2025/0349464 A1
(43) Pub. Date: Nov. 13, 2025

(54) Method for Producing a Winding for an Inductive Component and Inductive Component

(71) Applicant: Würth Elektronik eiSos GmbH & Co. KG, Waldenburg (DE)

(72) Inventor: Dirk Knorr, Waldenburg (DE)

(21) Appl. No.: 18/868,451

(22) PCT Filed: May 26, 2023
(86) PCT No.: PCT/EP2023/064151

§ 371 Date: Nov. 22, 2024

(30) Foreign Application Priority Data
May 30, 2022 (DE) 10 2022 205 342.7

(51) Int. Cl. H01F 41/061; H01F 27/28

(52) U.S. Cl. CPC H01F 41/061; H01F 27/2847

(57) ABSTRACT

The invention relates to a method for producing a winding for an inductive component with the steps of: producing a sheet-like, one-piece and electrically conductive blank, the blank having at least a first connecting portion, a second connecting portion and a strip-shaped winding portion of a constant width, and deforming the sheet-like blank to form a winding by means of wrapping the winding portion around a bending form.

### FIELD OF THE INVENTION

The invention relates to a method for producing a winding for an inductive component. The invention also relates to an inductive component with a one-piece winding, which has a first connecting portion and a second connecting portion.

### BACKGROUND

The invention is intended to improve a method for producing a winding for an inductive component and to improve an inductive component with a one-piece winding.

In the case of windings for inductive components, in particular in the case of windings that are intended for great current intensities, it is disadvantageous with respect to the electrical properties if the connecting portions have to be connected to the winding wire, for example have to be soldered or welded. The connecting point always has different electrical properties than the connecting portion and/or the winding wire. Machine production and in particular fully automatic production of one-piece windings is problematic however.

### SUMMARY

In the method according to the invention, the winding is produced from a sheet-like, one-piece and electrically conductive blank, the blank having a first connecting portion and a second connecting portion. The connecting portions serve for the connection to further electrical components, for example a power supply or other electrical circuit. Connected in one-piece to the two connecting portions is a strip-shaped winding portion of a constant width. This winding portion has a constant width, so that the finished winding has good electrical properties since the strip-shaped winding portion of a constant width behaves in a way comparable to a conventional winding wire. The strip-shaped winding portion also has a constant thickness, and consequently a constant ohmic resistance, over its entire length. Furthermore, the deforming of the sheet-like blank to form a winding is performed by means of wrapping the winding portion around a bending form. The wrapping of a winding wire around a bending form is known of course. Surprisingly, also, with careful selection of the geometrical form of the sheet-like blank, the strip-shaped winding portion can also very easily be wrapped around a bending form, and at the same time the connecting portions remain accessible on the completed winding. For example, the connecting portions are arranged in such a way that they lie in a common plane and can then for example be soldered to solder pads on a printed circuit board. The method according to the invention allows a winding for an inductive component to be created in a very easy way, the winding being formed in one piece.

According to the invention, in a method for producing a winding for an inductive component, the following steps are provided: producing a sheet-like, one-piece and electrically conductive blank, the winding blank being formed in one piece and having at least a first connecting portion, a second connecting portion and a strip-shaped winding portion of a constant width, and deforming the sheet-like blank to form a winding by means of wrapping the winding portion around a bending form.

In a development of the invention, to form a winding, the winding portion is wrapped around a cylindrical bending form, whereby the winding portion is given the form of a helix.

The usual form of a winding for an inductive component is a helix. Surprisingly, a helix can also be successfully formed with a one-piece sheet-like blank if the geometrical form of the blank is formed appropriately.

In a development of the invention, the bending form consists of magnetically conductive material and after forming the winding forms a core of the inductive component.

As a result, the core of the inductive component can at the same time provide the bending form. For example, before being deformed, the sheet-like blank is coated and thereby given an electrically non-conductive layer on its outside.

In a development of the invention, the sheet-like, one-piece and electrically conductive blank is produced by means of stamping out from an electrically conductive metal sheet.

In this way, blanks can be produced in high numbers very easily and in a fully automated manner.

The problem addressed by the invention is also solved by an inductive component with a one-piece winding, the winding having a first connecting portion, a second connecting portion and a strip-shaped winding portion of a constant width, the winding being produced from a sheet-like blank by means of wrapping around a bending form.

In a development of the invention, a core of magnetic material is provided, the winding portion being wrapped around the core.

### BRIEF DESCRIPTION OF THE DRAWINGS

Further features and advantages of the invention emerge from the claims and the following description of a preferred embodiment of the invention in conjunction with the drawings. In the drawings:

FIG. 1 shows a sheet-like blank for producing a winding obliquely from above,

FIG. 2 shows the sheet-like blank of FIG. 1 from the side,

FIG. 3 shows the sheet-like blank of FIG. 1 from above,

FIG. 4 shows a winding produced from the blank of FIG. 1 from the side and

FIG. 5 shows the winding of FIG. 4 with a bending form used as the core of the inductive component.

### DETAILED DESCRIPTION

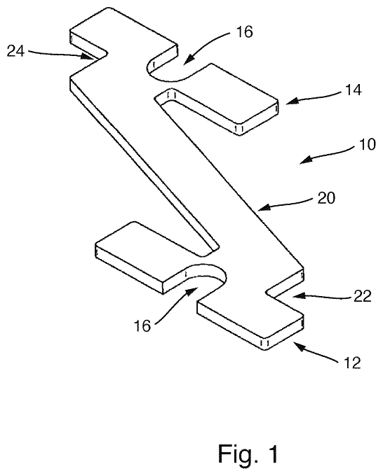

FIG. 1 shows a sheet-like blank 10 for producing a winding for an inductive component. The blank 10 has a first connecting portion 12 and a second connecting portion 14. On the finished winding, the two connecting portions 12, 14 are intended for being connected to an electrical circuit, for example an electrical power supply or the like. Each of the connecting portions has a generally rectangular outline with a U-shaped cut-out 16. The U-shaped cut-out may be used for example for aligning the connecting portions 12, 14 on the finished winding with positioning pins on a printed circuit board.

Provided between the two connecting portions 12, 14 is a winding portion 20, which is of a strip-shaped form and has a constant width. Also provided between the winding portion 20 and the connecting portions 12 there is in each case a transitional portion 22, 24, the side edges of the transitional portions respectively being arranged at an angle of more than 90° to the side edges of the winding portion 20. The side edges of the transitional portions 22, 24 are however arranged perpendicularly to the side edges of the connecting portions 12, 14 into which they merge. The transitional portions 22, 24 are intended for ensuring after deformation the transition from the then usually helical winding into the planar connecting portions 12, 14.

The winding portion 20 is arranged obliquely in relation to the mutually facing side edges of the connecting portions 12, 14. This has the overall effect of creating a Z-like form of the blank. The angle between the connecting portions and the length of the winding portion 20 can then establish the lead angle of the finished winding and also the number of turns of the winding. The connecting portions 12, 14 are wider than the winding portion 20.

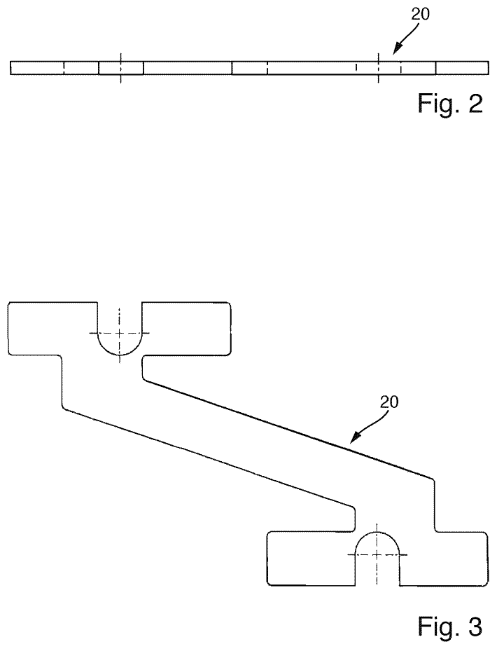

FIG. 2 shows a side view of the blank 20. The blank 20 has a constant thickness over its entire surface area. The blank 20 is for example stamped out from a metal sheet of a constant thickness.

FIG. 3 shows the blank 20 in a view from above.

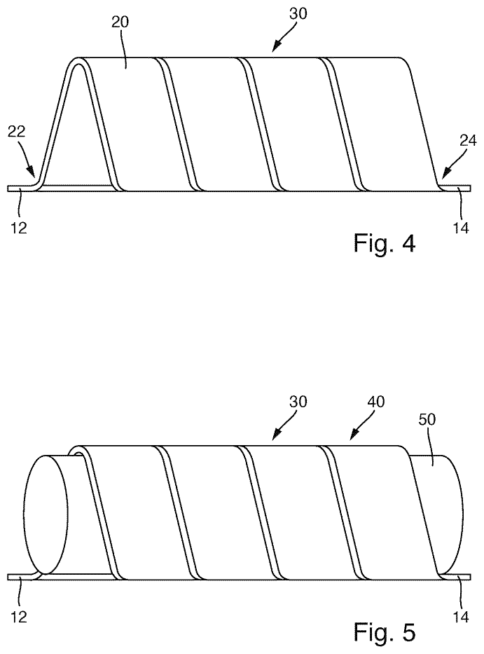

FIG. 4 shows a winding 30, which has been produced from the sheet-like blank 20 by wrapping the winding portion 20 around a bending form. The helical form of the winding portion 20 can be seen. It can also be seen that the connecting portions 12, 14 are arranged in the same plane and have not been deformed. The transitional portions 22, 24 form the transition from the planar connecting portions 12, 14 arranged in a common plane to the winding portion 20 deformed into a helix.

The winding 30 has a helix, which has altogether four turns. The number of turns can be changed by changing the length of the winding portion 20 or else by the diameter of a bending form used when performing the wrapping.

FIG. 5 shows an inductive component 40 with the winding 30. Arranged inside the cavity formed by the winding is a core 50 of magnetically conductive material. The core 50 is of a circular-cylindrical form and at the same time forms the bending form when producing the winding 30. For example, the connecting portion 12 is securely held in a winding machine and then the winding portion 20 is wrapped around the core 50, which also forms the bending form, so that the helical form of the winding 30 is obtained. The connecting portion 14 is then arranged in such a way that it is in a common plane with the connecting portion 12.

The connecting portions 12, 14 can then be used for connecting the inductive component 40 to solder pads on a printed circuit board.

The invention allows the fully automated production of inductive components with one-piece windings.

1. A method including steps for producing a winding for an inductive component, comprising:
producing a sheet-like, one-piece and electrically conductive blank, the blank having at least a first connecting portion, a second connecting portion and a strip-shaped winding portion of a constant width, and
deforming the sheet-like blank to form a winding by means of wrapping the winding portion around a bending form.

2. The method according to claim 1, wherein, to form the winding, the winding portion is wrapped around a cylindrical bending form, whereby the winding portion is given the form of a helix.

3. The method according to claim 1, wherein the bending form consists of magnetically conductive material and after forming the winding forms a core of an inductive component.

4. The method according to claim 1, wherein the sheet-like, one-piece and electrically conductive blank is produced by means of stamping out from an electrically conductive metal sheet.

5. An inductive component comprising:
a one-piece winding, including
a first connecting portion,
a second connecting portion and
a strip-shaped winding portion of a constant width,
the winding being produced from a sheet-like blank by means of wrapping around a bending form.

6. The inductive component of claim 5, wherein a core of magnetic material is provided, the winding portion being wrapped around the core.
